(19) United States
(12) Patent Application Publication
(10) Pub. No.: US 2011/0113023 A1
(43) Pub. Date: May 12, 2011

(54) SYSTEM METHOD AND SOFTWARE APPLICATION FOR IMPLEMENTING A GOOGLE LIKE SEARCH IN A SOFTWARE

(76) Inventor: Jurgen Van Gucht, Grimbergen (BE)

(21) Appl. No.: 12/614,394

(22) Filed: Nov. 7, 2009

(51) Int. Cl. G06F 17/30

(52) U.S. Cl. 707/707; 707/E17.108

(57) ABSTRACT

The present invention provides a system, method, and software application that mimics the Google® search engine on the web. Because of copyright laws, it is illegal to copy web articles their content and place them in a software or database unless you have permission from the copyright owner. The invention is to implement a software product with a database that solely contains the articles metadata (such as title, category, hyperlink) and that uses the (hidden) hyperlinks to open the articles content in a separate web browser when the user double-clicks the article from the grid in the software. As a result, no copyright infringement is possible and the software and its database can be updated (automatically) with updated articles. There is also an (intelligent) search or filter possibility so users can easily search or filter through all the articles from within the software.

### FIELD OF THE INVENTION

This invention relates generally to software programs that use an (intelligently) searchable database of articles metadata with (hidden) hyperlinks and use an (external) web browser to view the articles content.

### DESCRIPTION OF THE BACKGROUND ART

It is very useful to create a software program with a database that allows users to search and filter web articles prior to going on the internet. The software could for instance be a tax software with web articles viewed in a grid that is fully searchable, with all its metadata in place, (such as title, category) and whereby the user can decide if he/she opens the web article in a web browser. The result is that the owner of the software is not required to have a copyright license for each article that is contained in the database, thus allowing the software owner to freely implement his/her database, same as in the Google® search engine from Google, Inc. of Mountain View, Calif., you search the web articles through their metadata. Hereby, a knowledge/expert database of articles can be implemented on any matter and a much more powerful search can be implemented than via/through a search engine like the Google® search engine.

### SUMMARY

The present invention provides a system, method, and software application that mimics the Google® search engine on the web.

Because of copyright laws, it is illegal to copy web articles their content and place them in a software or database unless you have permission from the copyright owner.

The invention is to implement a software product with a database that solely contains the articles metadata (such as title, category, hyperlink) and that uses the (hidden) hyperlinks to open the articles content in a separate web browser when the user double-clicks the article from the grid in the software.

As a result, no copyright infringement is possible and the software and its database can be updated (automatically) with updated articles. There is also an (intelligent) search or filter possibility so users can easily search or filter through all the articles from within the software

### BRIEF DESCRIPTION OF THE DRAWINGS

FIG. 1 is screen shot of such a software, a corporate tax software with web article metadata, whereby the user can search/filter in any way possible and can open the desired web article in a web browser of any kind.

### DETAILED DESCRIPTION OF THE PREFERRED EMBODIMENTS

The present invention provides a system, method, and software application system, method, and software application that mimics the Google® search engine on the web.

Because of copyright laws, it is illegal to copy web articles their content and place them in a software or database unless you have permission from the copyright owner.

The invention is to implement a software product with a database that solely contains the article metadata (such as title, category, hyperlink) and that uses the (hidden) hyperlinks to open the article content in a separate web browser when the user double-clicks the article from the grid in the software.

As a result, no copyright infringement is possible, and the software and its database can be updated (automatically) with updated articles. There is also an (intelligent) search or filter possibility so users can easily search or filter through all the articles from within the software.

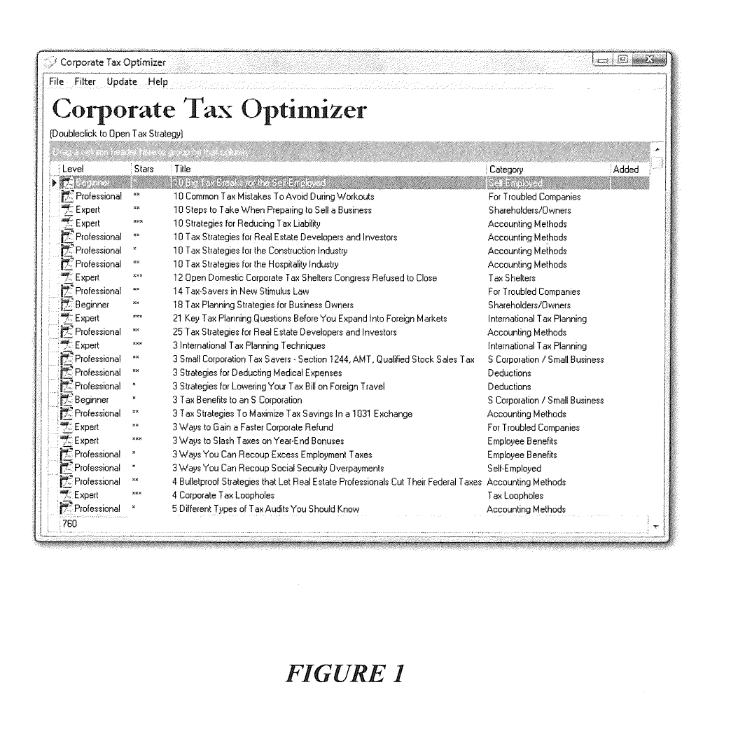

FIG. 1 is an example of such a software, a corporate tax software with web articles metadata, whereby the user can search/filter in any way possible and can open the desired web article in a web browser of any kind.

It is also possible that instead of a web article, a file on the web gets opened directly (for instance an Adobe pdf file gets downloaded).

It is not required for the web browser to be an external web browser, it could as well be an embedded/internal web browser of any kind.

The metadata or data that corresponds with each article in the database can contain all kinds of information about the articles such as category, title, etc.

The hyperlink can be visible or invisible, it does not need to be a hyperlink by definition, it could as well be a link/web address of any kind.

It is also possible that the articles themselves with their content are implemented in the software itself web based, or not. For instance, some articles are not copyright protected and can be implemented as Adobe pdf files that open up when the user views the articles.

An (intelligent) search or filter can be implemented in the database or software application thus to help the users easily find the articles.

There can be an (automatic) update functionality for instance, whereby the articles data and/or its hyperlinks are updated. For instance, the software has an auto-update feature to update and/or create/remove articles (data) from the database or software.

The implemented grid, table or other method to view the articles allows the user to open the file/article in any way possible (such as by double-clicking the article data of the grid, the web-based article opens up in a web-browser).

The users can also score, comment, or give any ratings to the articles in any way possible (such as comment on articles in a forum).

The users can (automatically) add/remove/update articles metadata in any way possible (for instance, a CPA or tax adviser adds a tax article metadata (including hyperlink) to the database by sending the article metadata to a software web server. whereby upon approval by an administrator it is transmitted to the users of the software and automatically updated in their databases).

The database implementation/representation can not only be a grid, but of any form possible. For instance, like an HTML-enabled table.

A web based software implementation is also possible whereby for instance, the software is a Java or HTML application and the database is also residing on a web server and an internet-based search on the articles metadata is possible.

1. A system, method, and software application of any kind which contains/uses a database of any kind
And whereby a list of web-based articles metadata of any kind are implemented in its database with/by/through (hidden) hyperlinks of any kind
And whereby the web-based articles themselves, their content, are not residing in the database or software itself, but externally on a (web)server of any kind in any way possible
And whereby a user can see, search or filter the web-based articles data (such as title, category, others) in the software in any way possible (such as in a grid) and can also, through its (hidden) hyperlink, open the desired website article and view its content in a web browser of any kind.

2. The system, method, and software application of claim 1 wherein the (hidden) hyperlinks in the database or software opens up a file on the web of any kind (for instance, opening an Adobe pdf file, Word file, Powerpoint file).

3. The system, method, and software application of claim 1 wherein the database or software with (hidden) hyperlinks contain any kind of information/(meta)data about the articles (for instance, titles, categories, or others).

4. The system, method, and software application of claim 1 wherein the web browser is an external program of any kind (such as Internet Explorer), or whereby it is an embedded/internal web browser of any kind.

5. The system, method, and software application of claim 1 wherein articles (and their contents) are also implemented in the software itself instead of web-based, as such the metadata includes the content as well (for instance, some articles are pdf-based and are located in the database or software itself).

6. The system, method, and software application of claim 1 wherein there is a (intelligent) search or filter possibility of any kind implemented in the database or software.

7. The system, method, and software application of claim 1 wherein the articles metadata, including the (hidden) hyperlinks, are (automatically) updated in any way possible. (For instance, the software has an auto-update feature to update and/or create/remove articles metadata from the database or software).

8. The system, method, and software application of claim 1 wherein there is a grid of any kind that shows the articles metadata in the database or software so the user can open the (hyperlinked) file/article in any way possible (such as by double-clicking the article metadata of the grid, the web-based article opens up in a web-browser).

9. The system, method, and software application of claim 1 wherein an (intelligently) searchable software/database with articles metadata is implemented with (hidden) hyperlinks that uses an (external) web browser to view the articles content upon a user his/her request.

10. The system, method, and software application of claim 1 wherein the users scores, comments or gives any ratings to the articles metadata in any way possible (such as comment on articles in a forum).

11. The system, method, and software application of claim 1 wherein the users (automatically) add/remove/update articles metadata in any way possible (For instance, a CPA or tax adviser adds a tax article to the database by sending the article metadata with hyperlink to a software web server whereby upon approval by an administrator it is transmitted to the users of the software and automatically updated in their databases).

12. The system, method, and software application of claim 1 wherein the database and/or its representation (such as through a grid) is of any form and implemented in any way possible (such as like an HTML-enabled table and article).

13. The system, method, and software application of claim 1 wherein the software and/or database are internet/web-based in any way possible. (For instance, the software is in the form of a Java application or HTML application that is implemented on a webserver and the database is also implemented on a webserver and an internet-based search on the articles metadata is possible).

14. (canceled)

15. (canceled)

16. The system, method, and software application of claim 1 wherein an offline/online search engine of any kind is implemented with a searchable grid of any kind (with articles metadata) that opens up (web) articles in an internal/external web browser of any kind with/or through its (hidden) hyperlinks.

17. The system, method, and software application of claim 1 wherein an online search engine (such as Google® search engine) uses/implements an internet/web-based application selected from the group consisting of one or more of (i) an internal/external web browser of any kind with/or through its (hidden) hyperlinks, (ii) a Java application that is implemented on a webserver, (iii) an HTML application that is implemented on a webserver, and (iv) a database that is implemented on a webserver.

18. The system, method, and software application of claims 1, 2, 3, 4, 5, 6, 7, 8, 9, 10, 11, 12, 13, 16 or 17 wherein the (hidden) hyperlink is a (hidden) link and/or web address of any kind, it does not need to be a hyperlink by definition.)

19. The system, method, and software application of claims 1, 2, 3, 4, 5, 6, 7, 8, 9, 10, 11, 12, 13, 16 or 17 wherein the data or metadata is of any form possible (such as title, category, hyperlink, external data, searching/classification data), it does not limit itself to the article (meta)data itself.
